(19) United States
(12) Patent Application Publication
(10) Pub. No.: US 2013/0319997 A1
(43) Pub. Date: Dec. 5, 2013

(54) KEEP-WARMING DEVICE WITH TIME CONTROL FUNCTION

(71) Applicant: Ming-Yi CHAO, Taipei Hsien (TW)

(72) Inventor: Ming-Yi CHAO, Taipei Hsien (TW)

(21) Appl. No.: 13/484,295

(22) Filed: May 31, 2012

(51) Int. Cl. H05B 3/00; H05B 3/02; H05B 3/14; H05B 1/02

(52) U.S. Cl. 219/492; 219/553; 219/548; 219/509

(57) ABSTRACT

A portable keep-warming device with time control function is proposed. A carbon film on a keep-warming sheet of the keep-warming device is mixed with silver so as to have greater resistance. Therefore, a small current will have a sufficient heat generated. Besides, the packaging of the keep-warming sheet with the carbon fiber layer and the metal gluing layer provides a greater heat dissipating area. The different time control modes provides the function of fast heating of the keep-warming sheet and long using time of the battery so as to increase the usages of the present invention. Furthermore, the appearance of the keep-warming sheet can be formed as desired to as to suit different usages of the keep-warming sheet.

### FIELD OF THE INVENTION

The present invention relates to keep-warming, and in particular to a keep-warming device with time control function.

### BACKGROUND OF THE INVENTION

The prior art keep-warming sheet has two types, one is heated electrically and one is heated chemically. For chemically keep-warming sheet, chemical materials are used for generating heat and the heat transfers outwards to have the function of heat keeping. These kinds of keep-warming sheets have short lifetime. Furthermore, it cannot be stopped as the chemical reaction is induced. After all the chemical material is reacted completely, it becomes useless and is deserted. The using time of this kind of keep-warming sheet is very short, for example, half hour to one hour. The cost is high and it had the problem of environment pollution. Thus users must buy the keep-warming sheet again and again. It is time and labor consumed and is uneconomic.

For electric keep-warming sheet, such as heating wires (copper wires or tungsten wires) are used in heating. Such kind of heating source has very small resistance and thus larger current is necessary. As a result battery lifetime is very short.

Above mentioned prior art keep-warming sheet has the problems of short lifetime and is un-reusable. Therefore, there is an eager demand for a novel keep-warming sheet which can improve the prior art defects.

### SUMMARY OF THE INVENTION

The present invention relates to a portable keep-warming device with time control function, wherein he carbon film on the keep-warming sheet is mixed with silver so as to have greater resistance. Therefore, a small current will have a sufficient heat generated. Besides, the packaging of the keep-warming sheet with the carbon fiber layer and the metal gluing layer provides a greater heat dissipating area. The different time control modes provides the function of fast heating of the keep-warming sheet and long using time of the battery so as to increase the usages of the present invention. Furthermore, the appearance of the keep-warming sheet can be formed as desired to as to suit different usages of the keep-warming sheet.

To achieve above object, the present invention provides a portable keep-warming device, comprising: a keep-warming sheet including substrate; a carbon film mixed with silver so as to have higher impedance; and two ends of the carbon film are connected to two electrodes of a conductive wire loop so as to form as a complete electric conductive loop; a layer of carbon fiber enclosing the keep-warming sheet with the carbon film; and a metal glue layer enclosing the carbon fiber layer for providing the effect of heat disperse.

Furthermore, the present invention provides a portable keep-warming device, comprising: a keep-warming sheet including a substrate; and a carbon film mixed with silver; a battery; a switch connected between the keep-warming sheet and the battery for controlling current to flow from the battery to the keep-warming sheet; and a processor for controlling operations of the device; and a timer connected to the processor and the switch for time controlling all the elements of the devices.

### BRIEF DESCRIPTION OF THE DRAWINGS

FIG. 1 shows the block diagram of the present invention.

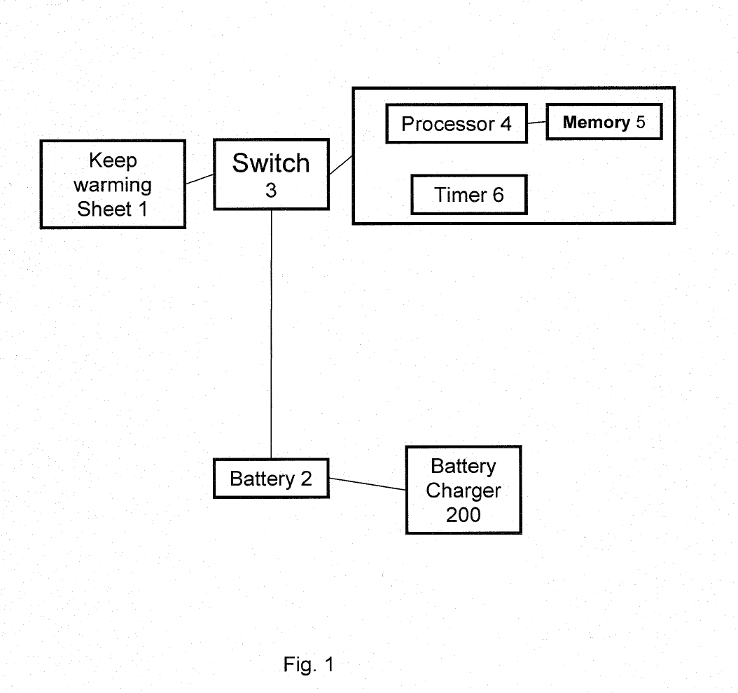

FIG. 2 is a schematic view about the structure of the present invention.

FIG. 3 is a schematic view showing the assembly of the present invention.

FIG. 4 shows an application of the present invention.

FIG. 5 shows another application of the present invention.

FIG. 6 shows a further application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The present invention relates to a portable keep-warming device with time control function. The present invention relates to the following elements.

A keep-warming sheet includes a substrate 100. Preferably, the substrate 100 is a foldable soft sheet, such as a PEC soft sheet. The substrate 100 is coated with a layer of carbon film 101 which is a heat conducted material. In the present invention, the carbon film 101 is mixed with silver for increasing impedance of the film. Generally, in the present invention, the impedance is as high as 5 ohms, while for a conventional keep-warming sheet, it is only 3 ohms. Since heat power is equal to the I (current)×R×R (resistances), for the same current, the higher the resistances, the greater the heat dissipated. Thus, the structure of the present invention provides higher power dissipating ability for the keep-warming sheet. The carbon film 101 can be printed upon the substrate 100. Two ends of the carbon film 101 are connected to two electrodes of a conductive wire loop to form as a complete electric conductive loop.

A battery 2 serves for providing power to the whole device of the present invention. In the present invention, the battery is a chargeable battery and is replaceable from another one having the same types.

A switch 3 is connected between the keep-warming sheet 1 and the battery 2 for controlling current to flow from the battery to the keep-warming sheet 1.

A processor 4 serves for controlling the operation of the whole device.

A memory 5 is connected to the processor 4 for storing the data used in the present invention.

A timer 6 is connected to the processor 4 and the switch 5 for time controlling all the elements of the devices.

The present invention provides the following control modes.

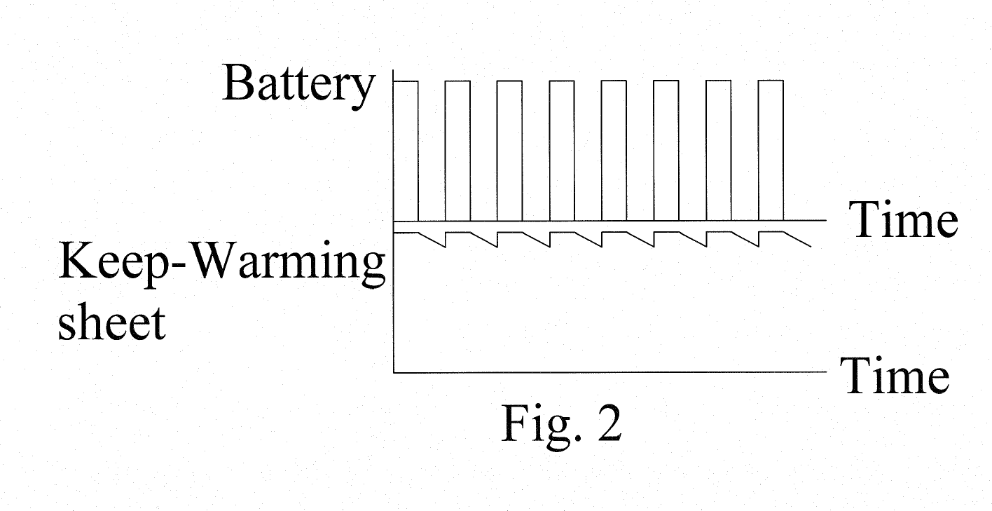

A time control mode serves for controlling charging time of the current from the battery 2 to the carbon film 101. In a normal operation, the current of the present invention is a pulse current (referring to FIG. 2).

Relations of the temperature of the carbon film 101 with respective to the charging time is illustrated. It is illustrated that for a short time period, even no current is charged to the carbon film 101, the temperature decrement is very small. Thus, it is unnecessary to charge to the carbon film 101 always. Therefore, in the present invention, pulse current is used to achieve the object of power saving and thus the using time of the battery 2 is prolonged. In a well control mode, the using time of the battery 2 can be prolonged to 4 to 6 times so that the using time of the battery 2 is as long as 4 hours. The prior art keep-warming sheet has short using time so that the whole usage of the keep-warming sheet is confined.

A fast charging mode provides a greater current to the carbon film 101 as the device is initially actuated so that the carbon film 101 can be heated in a very short time period.

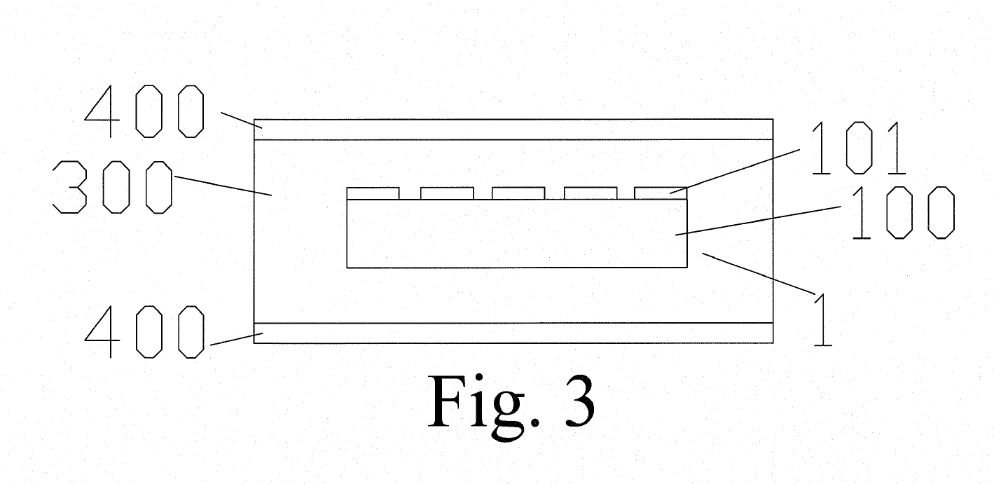

FIG. 3 shows the packaging way of the keep-warming sheet 1. Firstly, a layer of carbon fiber 300 encloses the keep-warming sheet 1. The carbon fiber 300 has the effect of keep-warming so as to keep the temperature of the carbon film 101 for a very long time period. Furthermore, a layer of metal glue 400 encloses the carbon fiber layer 300 for providing the effect of heat dispersing to expand the whole warming area of the keep-warming sheet 1 to several times of the original area. No only a small volume of the keep-warming sheet 1 can provides a greater area for heat dissipation. Above mentioned packaging structure is waterproof.

Above mentioned structure can be widely used in many fields. For example, the structure is used as a shoe pad to emit sufficient heat to feet of the user. Besides, the structure can be widely used to the clothes, trousers, handles (such as handles of golf rods), gloves, medical usages, etc. The present invention is usable for all objects needing keep-warming.

Furthermore, the present invention can be used repeatedly for a very long time.

The present invention is mainly used in many different forms. Preferably, three forms are provided, which provide greater usages in many different objects used in daily life.

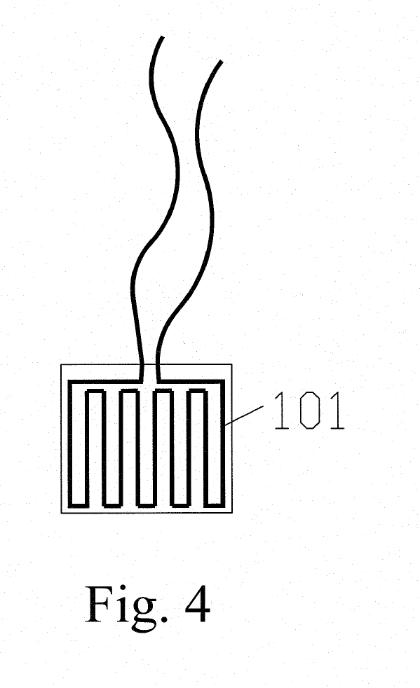

An approximate rectangular keep-warming sheet 1 (referring to FIG. 4) with carbon film 101 thereon is suitable for using in shoe pads, gloves, etc.

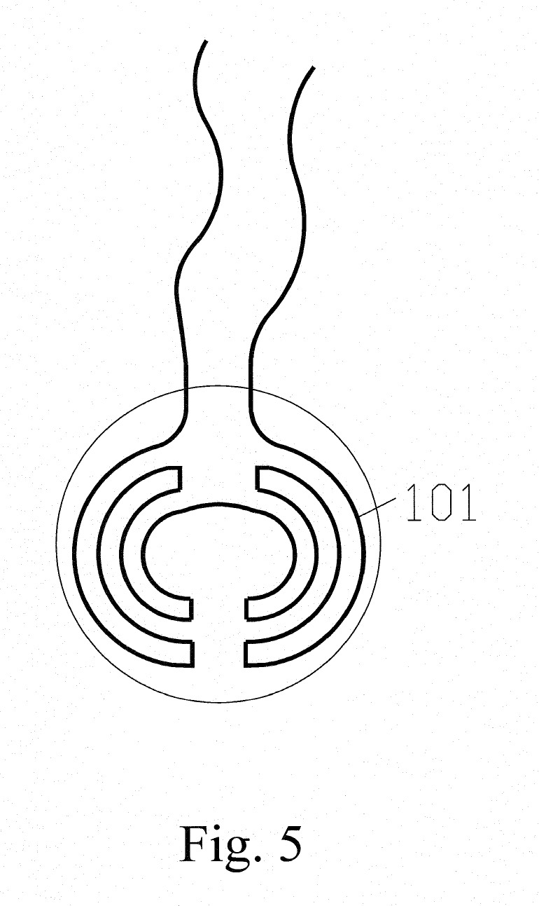

An approximate round keep-warming sheet 1 (referring to FIG. 5) with carbon film 101 thereon is suitable for packages for generating heat to keep warms.

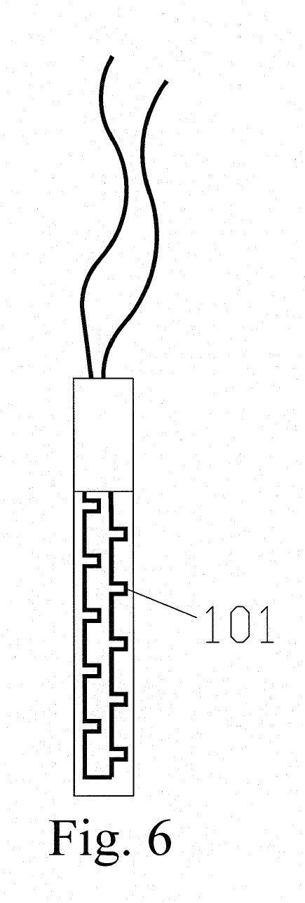

An approximate oblong keep-warming sheet 1 (referring to FIG. 6) with carbon film 101 thereon is suitable for clothes, trousers, pillows, pads, and some medical usages.

Advantages of the present invention are that the carbon film is mixed with silver so as to have greater resistance. Therefore, a small current will have a sufficient heat generated. Besides, the packaging of the keep-warming sheet with the carbon fiber layer and the metal layer provides a greater heat dissipating area. The different time control modes provides the function of fast heating of the keep-warming sheet and long using time of the battery so as to increase the usages of the present invention. Furthermore, the appearance of the keep-warming sheet can be formed as desired to suit different usages of the keep-warming sheets.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A portable keep-warming device, comprising:
a keep-warming sheet including
a substrate;
a carbon film mixed with silver so as to have a high impedance; and two ends of the carbon film being connected to two electrodes of a conductive wire loop to form as a complete electric conductive loop.

2. The portable keep-warming device as claimed in claim 1, further comprising:
a carbon fiber layer enclosing the keep-warming sheet with the carbon film;
a metal glue layer enclosing the carbon fiber layer for heat dispersion.

3. The portable keep-warming device as claimed in claim 1, wherein the keep-warming sheet is one of an approximate rectangular keep-warming sheet; an approximate round keep-warming sheet; and an approximate oblong keep-warming sheet.

4. A portable keep-warming device, comprising:
a keep-warming sheet including
a substrate;
a carbon film mixed with silver so as to have a high impedance; and two ends of the carbon film are connected to two electrodes of a conductive wire loop to form as a complete electric conductive loop;
a battery;
a switch connected between the keep-warming sheet and the battery for controlling current to flow from the battery to the keep-warming sheet; and
a processor for controlling operations of the device.

5. The portable keep-warming device as claimed in claim 4, further comprising
a timer connected to the processor and the switch for time controlling all the elements of the devices.

6. The portable keep-warming device as claimed in claim 4, wherein the substrate is a soft sheet.

7. The portable keep-warming device as claimed in claim 4, wherein the substrate is a PEC.

8. The portable keep-warming device as claimed in claim 4, wherein the carbon film is printed upon the substrate.

9. The portable keep-warming device as claimed in claim 4, wherein the battery is a chargeable battery.

10. The portable keep-warming device as claimed in claim 5, wherein current from the battery to the carbon film is a pulse current.

11. The portable keep-warming device as claimed in claim 5, wherein a fast charging mode provides by the process which induces a greater current to the carbon film as the device is initially actuated so that the carbon film can be heated in a very short time period.

12. A portable keep-warming device with a time control function, comprising:
a keep-warming sheet;
a battery;
a switch connected between the keep-warming sheet and the battery for controlling current to flow from the battery to the keep-warming sheet;
a processor for controlling operations of the device;
a memory connected to the processor; and
a timer connected to the processor and the, switch for time controlling all the elements of the devices.

13. The portable keep-warming device as claimed in claim 11, wherein current from the battery to the carbon film is a pulse current.

14. The portable keep-warming device as claimed in claim 11, wherein a fast charging mode provides by the process which induces a greater current to the carbon film as the device is initially actuated so that the carbon film can be heated in a very short time period.
